(19) United States
(12) Patent Application Publication
(10) Pub. No.: US 2007/0050252 A1
(43) Pub. Date: Mar. 1, 2007

(54) Preview pane for ads

(75) Inventor: Kamal Jain, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/214,307

(22) Filed: Aug. 29, 2005

(51) Int. Cl. G06Q 30/00

(52) U.S. Cl. 705/14

(57) ABSTRACT

The user interfaces, methods and systems described herein facilitate user interaction with an ad space by conveying additional advertising content via a preview pane. By way of example, an electronic advertisement may be conveyed to a user in an ad space provided by a third party. A secondary advertisement providing associated information relating to the electronic advertisement may occur upon receiving a user indication. By way of another example, a user is provided with one or more ads from a plurality of different advertisers in a first ad space maintained by an ad space supplier. A user input identifying at least one of the ads from the plurality of different advertisers is received and in response a second ad space having a supplemental ad relating to the at least one ad identified by the user input is provided.

### BACKGROUND

As ever increasing numbers of people turn to the Internet for information and goods/services, many advertisers have recognized the potential for increased profits through advertising online (e.g., in conjunction with web portal sites, search engine sites, and/or email services). Advertising on search engine sites has become popular because many businesses have recognized that an individual who is searching for information related to a particular product or service may be likely to purchase that product or service. For example, if a user enters the term “flower” into a search engine, that user may be interested in purchasing flowers. Thus, a flower retailer may seek to place an ad on the search engine site during the particular period of time when the term “flower” is utilized as a search term by one or more users.

To optimize revenue, ad space providers often restrict the style and size of ads placed on their sites in order to show as many ads as possible in an uncluttered manner. Consequently, an advertiser placing an ad on a third party advertising venue may be limited to only a text ad consisting of a small number of letters. Given the small size of such ads, a user may not get enough information to appropriately choose which ad to click to obtain the information/goods/services that best match the user's needs. If a user does not interact with an ad to purchase the goods/services offered by a vendor, this typically results in less revenue for both the ad space supplier and the vendor.

Thus, for the long term viability and growth of online advertising ventures, it is important that ad space is utilized in an efficient manner and in a way that maximizes revenues for both the ad space operators and the advertisers. Therefore there exists a need to provide an interactive ad space that provides additional ad content without increasing clutter and that facilitates generating increased revenue.

### SUMMARY

This summary is not an extensive overview of the invention. It is not intended to identify key/critical elements of the invention or to delineate the scope of the invention. The sole purpose of this summary is to present some concepts relating to the invention in a simplified form as a prelude to the more detailed description that follows.

The user interfaces, methods and systems described herein facilitate a user's interaction with an advertiser. In one embodiment, a preview pane opens up when a user hovers a mouse pointer on an area of an online advertisement. The preview pane may be, for instance, a bubble having additional information about, links to and/or a preview of the vendor's web site and/or products or services offered for sale by the advertiser. The preview pane also may contain a navigation menu that allows a user to navigate the advertiser's web site. The preview pane also may provide additional working space, such as an order form to order products.

The preview pane has many advantages for ad space owners, users and advertisers. For instance, the preview pane allows users to quickly and easily abstract out the information they are interested in without adding clutter to the primary ad space. Unlike a pop-up ad, the preview pane allows the user to be in control of whether additional advertising information is presented. The preview pane can facilitate sales for the advertiser, which can lead to higher profits. By way of example, the preview pane may be used by an advertiser to provide a sales pitch to the user and, thus, entice the user to click over to the advertiser's site to place an order. This sales pitch may include such supplementary information as customer ratings and reviews, or the main business thrust of the merchant (e.g., full satisfaction guarantee or low prices, etc.). To further entice the user, an advertiser can provide a sample list of products and/or services available on its website, alone or together with prices and/or features. An advertiser also may use the preview pane to provide more targeted links in order to allow a user to quickly land on the page the user is interested in. By way of another example, an advertiser may provide a link that takes a user to a partially filled order page to order services/products offered by the advertiser (e.g., ordering a pizza, scheduling a doctor's appointment, etc.).

In one embodiment of an interactive user interface, an advertiser may provide a completely menu driven advertisement by enabling more hovering capability within the preview and navigation pane. For instance, a user may hover over the main ad and get a list of subclasses of the products, such as a list of categories. By way of example, if the advertiser is an electronics store, the subclasses may include video and audio, etc. In this example, if a user hovers over “audio,” the user is presented with another preview and navigation pane giving further subcategories, such as portable and full-size. The second preview pane may be enabled so that hovering over “portable” can present the user with further subcategories. This nested structure may continue on as necessary to preview and navigate the vendor's offerings.

Moreover, since viewing the preview pane requires either explicit or implicit user interaction of some sort, an advertiser can simply remove any link from the main ad and provide a link in the preview and navigation pane to reduce the likelihood of accidental/fraudulent clicks on its ad. This is particularly useful to the advertiser if the advertiser is paying by user interactions such as clicks. In addition, systems and methods of protecting an advertiser from accidental/fraudulent clicks or other user indications, such as CAPTCHA and other Human Interactive Proofs (HIPs), optionally may be utilized in the subject invention. By way of example, the user may be transferred to the vendor's site only when the user solves a puzzle that a human can solve rather easily but that a computer can take a long time to solve. This functionality serves to minimize the possibility that automated processes will enter the advertiser's site through the ad or that an advertiser will be charged for an accidental user indication.

The ad space supplier may provide tools to an advertiser to facilitate the creation of ads and preview panes. Exemplary tools are described in a commonly assigned patent application filed on Aug. 29, 2005, Attorney docket number MS314056.01/MSFTP1128US, entitled “AUTOMATICALLY GENERATING CONTENT FOR PRESENTING IN A PREVIEW PANE FOR ADS.” The ad space supplier also may employ various mechanisms to monetize the subject invention. Exemplary methods and systems for monetizing the subject invention are described in a commonly assigned patent application filed on Aug. 29, 2005, Attorney docket number MS314043.01/MSFTP1127US, entitled “MONETIZING PREVIEW PANES FOR ADS.”

One exemplary user interface that facilitates user interaction with a vendor comprises an electronic advertisement conveyed to a user in an ad space provided by a third party and a secondary advertisement providing associated information relating to the electronic advertisement. The secondary advertisement occurs upon receiving a user indication such as a hover, a voice signal, an input device click and/or an eye gaze. The third party may be an email service, an application program, a web portal, and/or a search engine. The user interface may further comprise a navigation component that facilitates navigation of the advertiser's web site. The associated information may be one or more links to one or more of the vendor's landing pages, audio content, video content, multimedia content, a coupon, a map of the vendor's place of business, a preview of one or more pages of the vendor's online presence, and/or an order form, such as an order form that is automatically at least partially filled-in. The associated information may further provide one or more tertiary advertisements upon receiving another user indication. The user interface may be conveyed at least in part by a manufactured data signal.

One exemplary method of providing supplementary online advertising information to a user comprises providing one or more ads from a plurality of different advertisers in a first ad space maintained by an ad space supplier, receiving a user input identifying at least one of the ads from the plurality of different advertisers, and providing a second ad space having a supplemental ad relating to the ad identified by the user input. The supplemental ad may be one or more links to one or more web pages corresponding to an advertiser who placed the ad identified by the user input in the first ad space. The supplemental ad may be audio content, video content, multimedia content, a coupon, a map and/or a preview of one or more web pages. The user indication may be a hover over indication, an audio indication, a click indication and/or a visual indication. The ad space supplier may be an email server, an application program, a web portal and/or a search engine web page.

The method may further comprise providing a menu within the second ad space. The menu may relate to a web site affiliated with the advertiser who placed the ad identified by the user input in the first ad space. The method also may further comprise receiving a second user input relating to a portion of the supplemental ad, and providing a third ad space in response to the second user input. At least part of the exemplary method may be encoded by computer-executable instructions stored on computer-readable media and/or conveyed by a manufactured data signal.

One exemplary system for enhancing a third party online advertising venue comprises means for providing online advertisements from two or more separate advertisers to a user interacting with the third party online advertising venue, means for providing a second advertisement, and means for receiving a user indication from the user. The second advertisement may be associated with at least one online advertisement and the user indication may indicate at least one online advertisement associated with the second advertisement. Upon receiving the user indication, the means for receiving the user indication signals the means for providing the second advertisement to provide the second advertisement and the means for providing the second advertisement provides the second advertisement to the user in response to the signal from the means for receiving the user indication. The system may be conveyed by a manufactured data signal.

The following description and the annexed drawings set forth in detail certain illustrative aspects of the subject invention. These aspects are indicative, however, of but a few of the various ways in which the principles of the subject invention may be implemented. Other advantages and novel features of the invention will become apparent from the following detailed description of the invention when considered in conjunction with the drawings.

### BRIEF DESCRIPTION OF THE DRAWINGS

FIG. 1A is a block diagram of one example of a user interface that facilitates user interaction with an advertisement.

FIG. 1B is a block diagram of the user interface of FIG. 1A at a later time.

FIG. 2 is an illustration of a standard ad space for providing electronic advertisements.

FIG. 3 is an illustration of one example of a user interface that facilitates user interaction with an advertisement.

FIG. 4A is another illustration of one example of a user interface that facilitates user interaction with an advertisement.

FIG. 4B is another illustration of one example of a user interface that facilitates user interaction with an advertisement.

FIG. 5 is another illustration of one example of a user interface that facilitates user interaction with an advertisement.

FIG. 6A is another illustration of one example of a user interface that facilitates user interaction with an advertisement.

FIG. 6B is yet another illustration of one example of a user interface that facilitates user interaction with an advertisement.

FIG. 7 is a flowchart representing one example of a method of providing online supplementary advertising information.

FIG. 8 is a flowchart representing another example of a method of providing online supplementary advertising information.

FIG. 9 is a block diagram of one example of a system for enhancing an advertising venue.

FIG. 10 illustrates an exemplary computing architecture that can be employed in connection with the subject invention.

FIG. 11 illustrates an exemplary networking environment that can be employed in connection with the subject invention.

FIG. 12A is an illustration of one example of a user interface that facilitates user interaction with an advertisement.

FIG. 12B is an illustration of another example of a user interface that facilitates user interaction with an advertisement.

### DETAILED DESCRIPTION

Various aspects of the subject invention are now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention. Although the methodologies are shown in the figures and described as a series of blocks, the subject invention is not limited by the order of the blocks, as some blocks may occur in different orders and/or concurrently with other blocks. Moreover, not all illustrated blocks may be required to implement the methodologies.

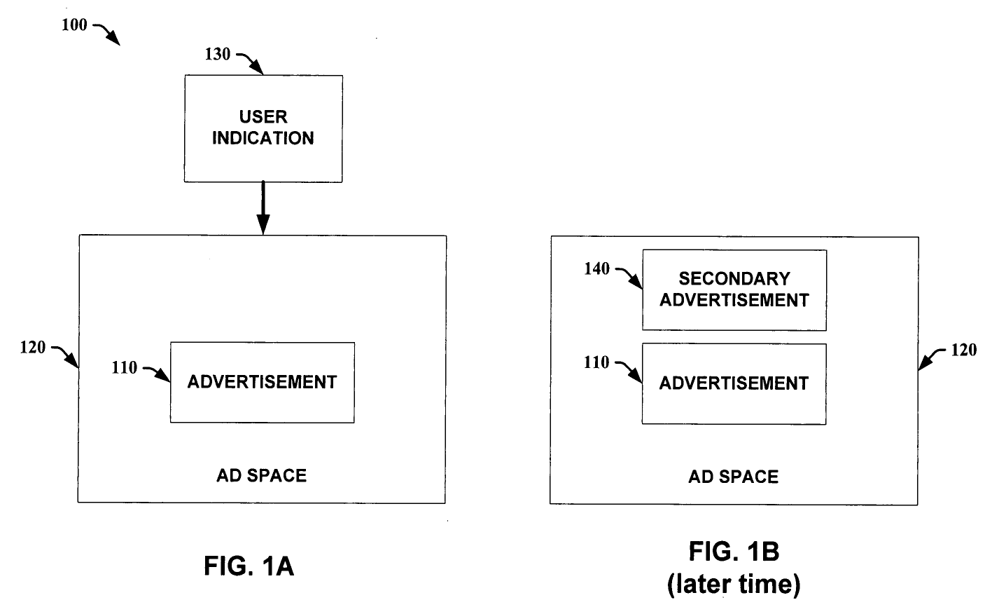

FIGS. 1A and 1B schematically illustrate one example of a user interface 100 that facilitates user interaction with a vendor shown at different times. The term vendor is used herein expansively to mean those entities offering for sale goods or services of all types, including both tangible and non-tangible goods, real property and intangible assets as well as services of any nature. The term vendor also is used herein to refer to entities that do not themselves make an offer for sale but provide a user with information or act as a conduit to route users to another entity. The term vendor also is used herein to refer to those entities that provide advertising services for others. Thus, the term vendor as used herein refers to any entity that desires to advertise for any reason.

The user interface 100 comprises an advertisement 110 presented to a user in an ad space 120. The advertisement 110 may be of any type including but not limited to visual, textual, graphical, photographic, audio, speech, video, multimedia and the like. The ad space 120 may be provided by a third party (i.e., a party other than the user or the vendor). The third party may be a web site, a search engine site, an application program, an email service, or any other third party site. A more detailed discussion of systems and methods for providing advertising in application programs, any and all of which are employable in the subject invention, are described in the commonly assigned U.S. patent application Ser. No. 11/139,750, filed on May 27, 2005 and entitled “ADVERTISING IN APPLICATION PROGRAMS.”

The user interface 100 may receive a user indication 130 and in response, provide a secondary advertisement 140. The user indication 130 may be an explicit user action, such as hovering an input device over the advertisement 110. The user indication 130 also may be a click of in input device or even speech. The input device may be, for example, a keyboard and/or a mouse and/or a microphone and the like. Other input devices currently existing and/or input devices yet to exist may be utilized to receive user indications 130 and are within the scope of the subject invention. For example, input devices to assess eye movement and gaze direction, thought processing, and/or body movement and the like, any of which, alone or in combination, may be used as input determinants. User indications 130 may also include implicit user actions. By way of example, artificial intelligence components may be employed to infer an implicit user indication 130. Such artificial intelligence components include but are not limited to neural networks, expert systems, Bayesian belief networks, fuzzy logic, data fusion engines and the like.

The secondary advertisement 140 may provide information associated with the advertisement 110. The associated information may include but is not limited to links to a landing page on the vendor's web site, audio content, video content, multimedia content and even a map to the vendor's place of business (e.g., provided by a MICROSOFT MAPPOINT LOCATION SERVER). By way of example, the secondary advertisement 140 may serve as a preview pane and provide links to navigate through the vendor's web site. By way of another example, the secondary advertisement may provide an order form that would allow the user to complete or partially complete a transaction with the vendor. In another aspect of the secondary advertisement 140, the order form, for instance, may be automatically fully or partially filled-in for the user.

The advertisements 110 and 140 may be, for example, online clickable advertisements that take a user to an entity's website. The advertisements 110 and 140 may also be interactive advertisements attached to, embedded in or otherwise conveyed by an email, an application program and the like. Thus, the subject invention is not limited to web portals and search engines. The advertisements 110 and 140 may also be non-visual enticements as well. By way of example, an audio advertisement may prompt a user to speak a certain word to land on the advertiser's site.

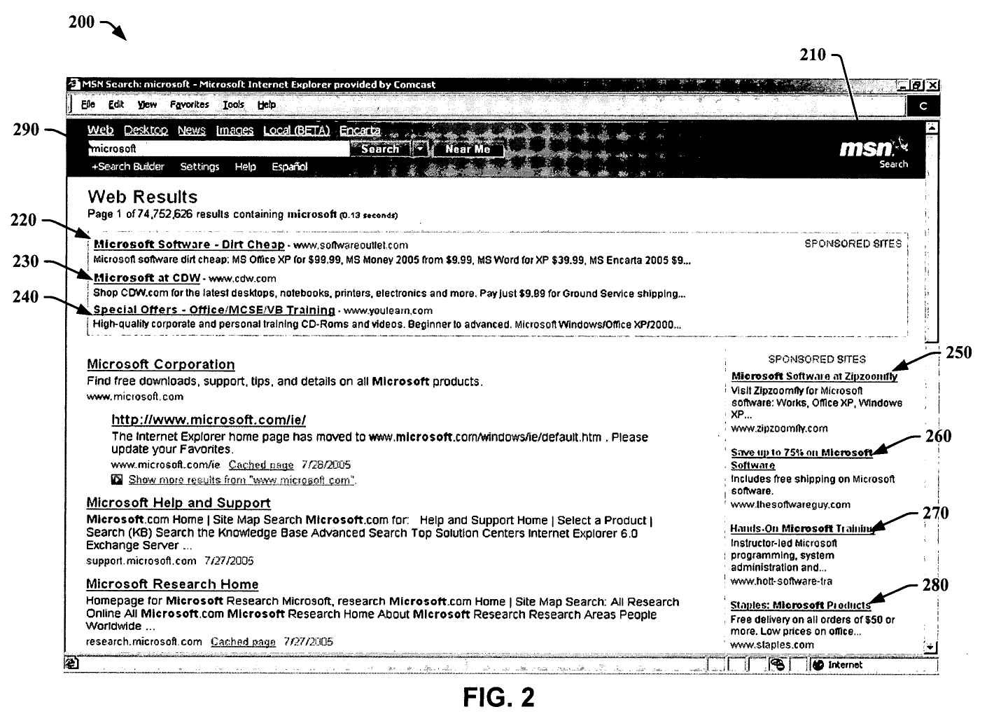

FIG. 2 is an illustration of a standard third party ad space 200 for providing advertisements. The third party 210 presents ads 220-280 to a user in response to a query 290. The third party 210 may charge a fee for an ad to be placed in the ad space 200, and this fee may be determined by a competition, such as an auction. More specifically, a search engine can receive a query 290 that includes one or more search terms that are of interest to a plurality of advertisers and the advertisers can place bids with respect to at least one of the search terms. By way of example, the bids may be based on the cost-per-click (CPC) rate and the click-through-rate (CTR). An advertiser associated with the highest bid may have its advertisement displayed upon a resulting page view. Auctioning advertising space associated with search terms is a substantial source of revenue for search engines, and because it directs users to an advertiser's products/services, can be a source of revenue for advertisers. A more detailed discussion of systems and methods for auctioning online ad space, any and all of which are employable in the subject invention, are described in the commonly assigned U.S. patent application Ser. No. 10/977,824, filed on Oct. 29, 2004 and entitled “SYSTEMS AND METHODS FOR DETERMINING BID VALUE FOR CONTENT ITEMS TO BE PLACED ON A RENDERED PAGE.”

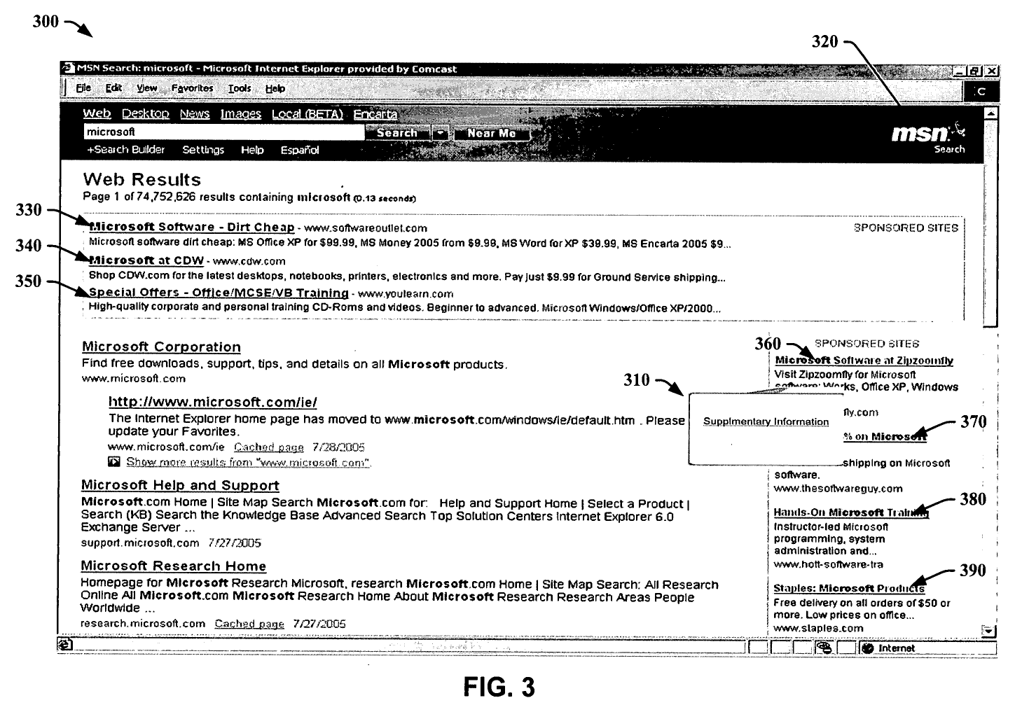

FIG. 3 is an illustration of one example of a user interface 300 that facilitates user interaction with an advertiser by providing supplementary information in a secondary advertisement 310 upon receiving a user indication. This secondary advertisement 310 serves to provide additional content in a user-controlled manner without adding clutter to the ad space. As shown, a third party 320 provides a user interface 300 to a plurality of advertisers 330-390. The advertisers 330-390 may be entities promoting products, goods and/or services of any type and nature regardless of whether the entity itself is providing the products, goods or services. For instance, the advertisers 330-390 may be entities that refer users to a vendor or otherwise provide advertising services to other entities. Moreover, the advertisers 330-390 are not limited to entities having an online presence. For instance, one or more advertisers 330-390 may be local businesses without web sites.

way of example, a user may place a cursor (not shown) over an ad 360 and activate the secondary advertisement 310. As explained above, a variety of different input devices may be employed by a user to activate the secondary advertisement, such as a keyboard, touchscreen, or microphone, and the subject invention is not limited to this particular embodiment. Similarly, the secondary advertisement 310 is not limited to visual information and may be, for instance, audio or multimedia content.

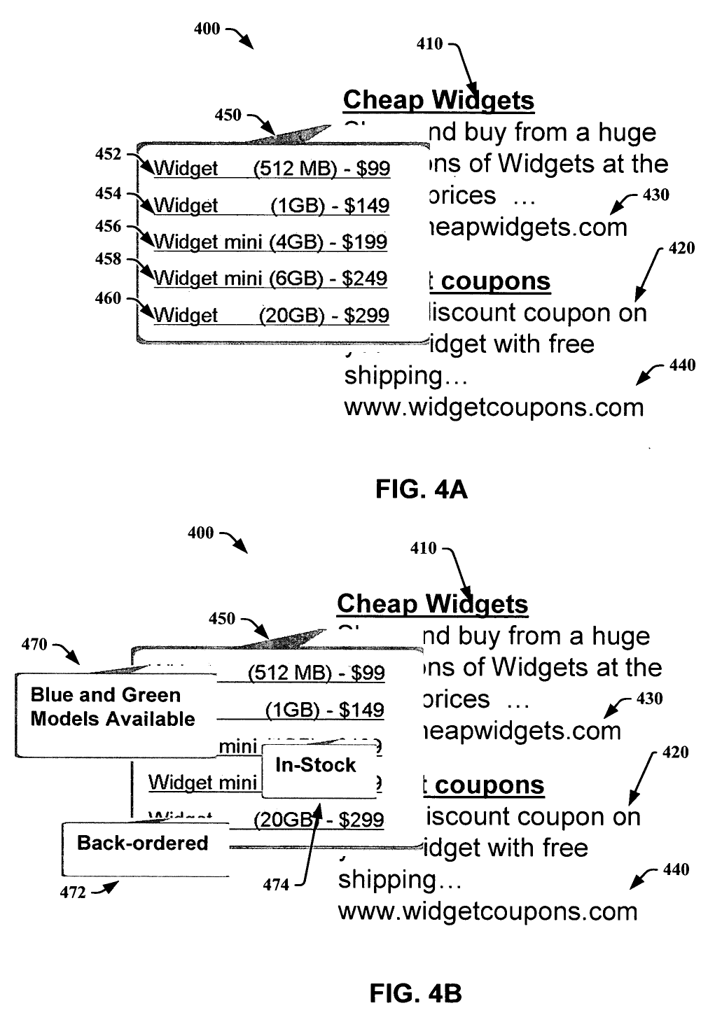

FIGS. 4A and 4B are other examples of an ad space 400 that facilitates user interaction with an advertisement. In these examples, the user is presented with ads 410 and 420 from a plurality of advertising entities 430 and 440. A supplemental advertisement 450 is displayed on user demand. As shown, the supplemental advertisement 450 provides additional information, such as model and price, about the products available for sale by the advertising entity 430. A user may navigate through an advertiser's online catalog quickly and easily by clicking on links 452-460 provided in the supplemental advertisement 450. A user also may obtain more additional information in tertiary ads 470-474 as shown in FIG. 4B. The tertiary ads 470-474 may be presented to the user simultaneously or in sequence and may be activated concurrently or successively. As in the previous examples, the user indications triggering the supplemental and tertiary ads may be of any type. Likewise, the supplemental and tertiary ads may be of any type. Furthermore, the ad space 400 may provide additional layers of ads and is not limited to three layers.

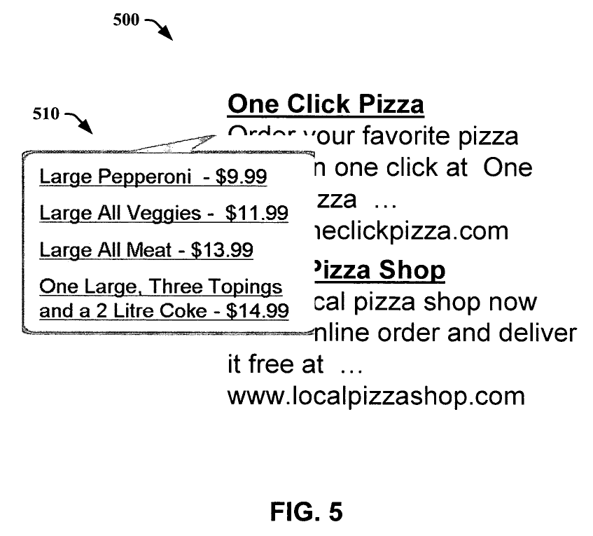

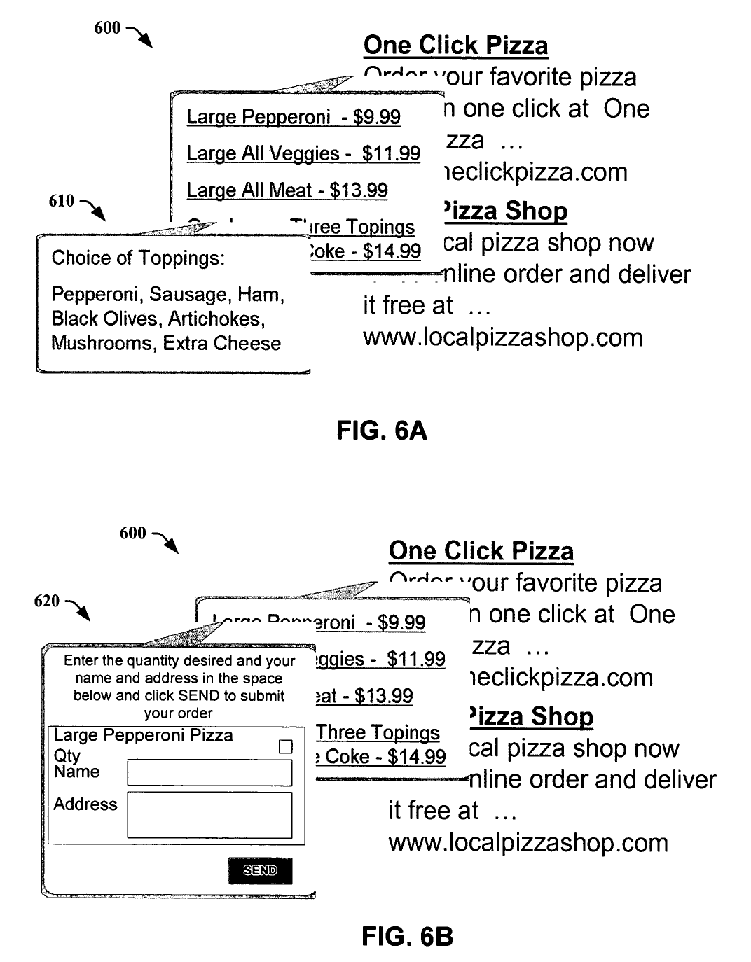

FIG. 5 is another illustration of one example of a user interface 500 that facilitates user interaction with an advertisement. FIGS. 6A and 6B show additional functionality of the user interface. As shown in FIG. 5, a user may receive a second advertisement 510 by providing an input (not shown). The second advertisement 510 may include product and price information and this may entice a user to purchase the advertiser's goods and/or services. The user may provide an additional indication (not shown) to obtain a third advertisement 610 as illustrated in FIG. 6A. The user interface 600 can provide a fourth, a fifth, and a sixth ad, etc. in a similar fashion. The user interface 600 is not limited in the number of ads it can provide and may be configured to provide any number of levels of advertisements. Moreover, each nested ad may be of the same or of different types, for instance, a mixture of text, audio, and pictures. As shown in FIG. 6B, a third advertisement may be an order form 620 that allows a user to order a product from the advertiser. The order form may be completely or partially filled-in by the user interface 600 to facilitate the purchase. This feature is particularly valuable to advertisers who do not maintain their own web sites to allow them to provide online ordering functionality.

The user interfaces described above may be conveyed on a network, in whole or in part, by data signals. These manufactured data signals may be of any type and may convey the user interfaces on any type of network. For instance, the user interfaces may be conveyed by electronic signals propagating on electronic networks, such as the Internet. Wireless communications techniques and infrastructures also may be utilized to convey the user interfaces.

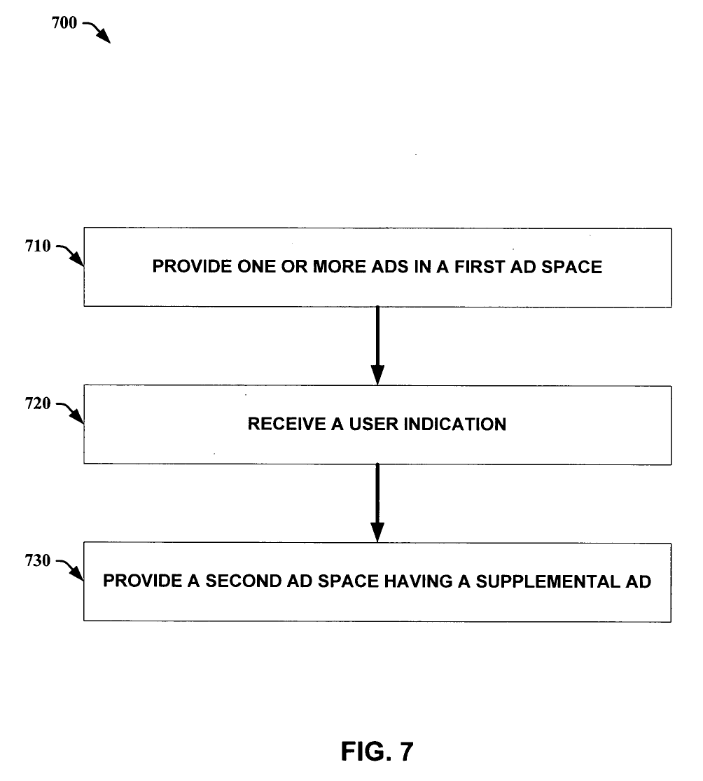

FIG. 7 is a flowchart representing one example of a method 700 of providing supplementary online advertising information. At step 710, one or more ads from a plurality of different advertisers are provided to a user in a first ad space maintained by an ad space supplier. By way of example, the ad space supplier may be an entity such as http://www.msn.com providing ad spaces such as those shown in FIGS. 1-6. At step 720, a user input identifying at least one of the ads is received. In response to the user input, the method proceeds to step 730 and a second ad space having a supplemental ad relating to the initial ad is provided. All types of user inputs (e.g., hover, click, speech, eye gaze, etc.) may be utilized in the method and any type of supplemental ad (e.g., web site preview, links, map, audio, video, multimedia, etc.) may be provided in response to the input. The method 700 may be implemented by computer-executable instructions stored on computer-readable media or conveyed by a data signal of any type.

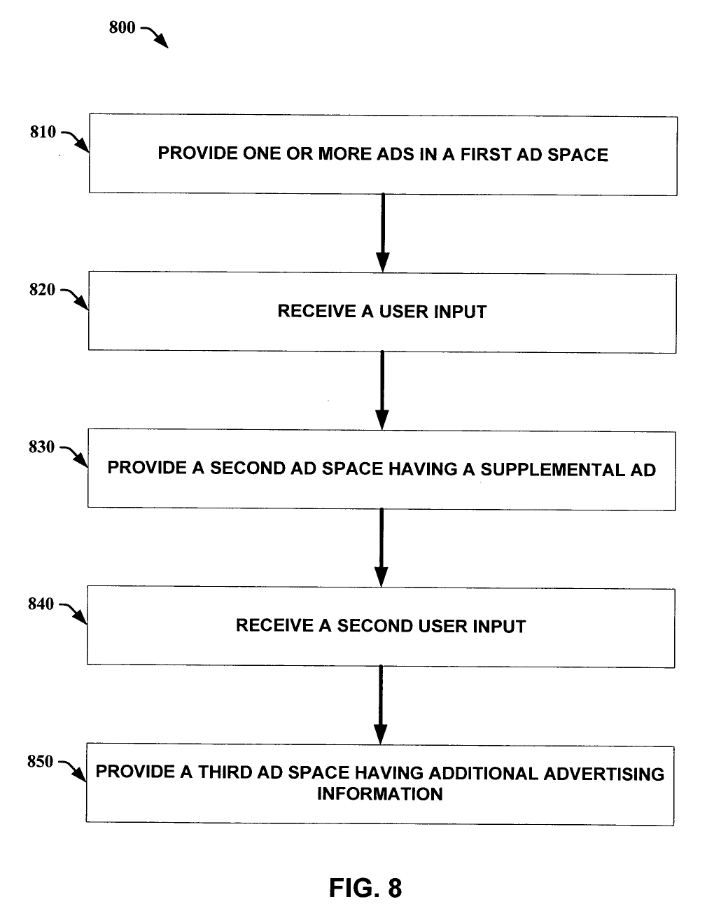

FIG. 8 is a flowchart representing another example of a method 800 of providing supplementary online advertising information. At step 810, one or more ads corresponding to different advertisers are provided in a first ad space. Upon receiving a first user input indicating a particular ad at step 820, a second ad space is provided at step 830. Upon receiving a second user input at step 840, a third ad space is provided at step 850. The process 800 may continue on to provide a fourth, a fifth, a sixth ad space, etc. and is not limited to the number of steps shown in FIG. 8. All types of user inputs (e.g., hover, click, speech, eye gaze, etc.) may be utilized in the method and any type of supplemental ad and additional advertising information (e.g., web site preview, links, map, audio, video, multimedia, etc.) may be provided in response to the input. The method 800 may be implemented by computer-executable instructions stored on computer-readable media or conveyed by a data signal of any type.

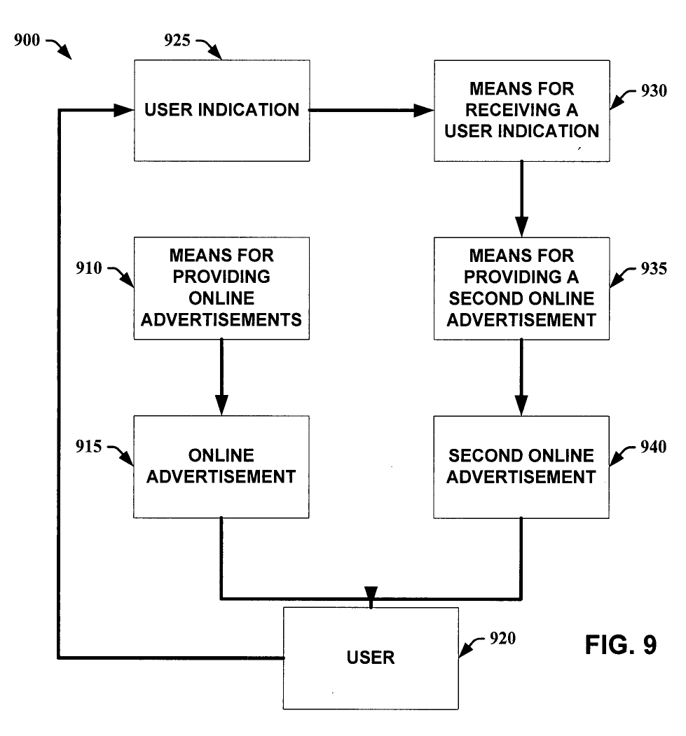

FIG. 9 is a block diagram of one example of a system 900 for enhancing an advertising venue. As shown, the means for providing online advertisements 910 provides an online advertisement 915 to a user 920. The means for providing online advertisements 910 may provide online advertisements from two or more separate advertisers, for instance, as shown in the figures corresponding to the exemplary user interfaces described above. Upon receiving the online advertisement 915, the user 920 may provide a user indication 925 indicating that the user 920 desires more information. The user indication 925 is received by the means for receiving the user indication 930, which signals the means for providing a second online advertisement 935 to provide a second online advertisement 940 to the user 920. The second online advertisement 940 may generally or more specifically relate to the online advertisement 915 and be of any type and provided in any manner. The system 900 may be expanded to provide any number of additional ads relating generally or more specifically to either the online advertisement 915 or the second online advertisement 940. The system 900 may be conveyed by a data signal of any type.

As used in this application, the term “means” is intended to refer to a computer-related entity, either hardware, a combination of hardware and software, software, or software in execution. For example, a means may be, but is not limited to being, a process running on a processor, a processor, an object, an executable, a thread of execution, a program, and/or a computer. By way of illustration, both an application running on a server and the server can be a means. One or more means may reside within a process and/or thread of execution and a means may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

The subject invention may operate in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the subject invention.

used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents. One or more components may reside within a process and/or thread of execution and a component may be localized on one computer and/or distributed between two or more computers.

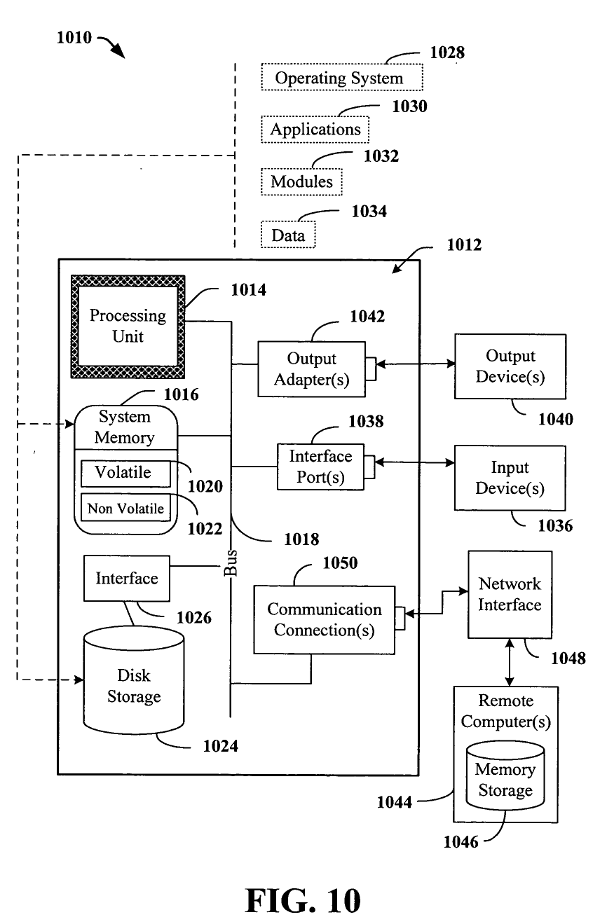

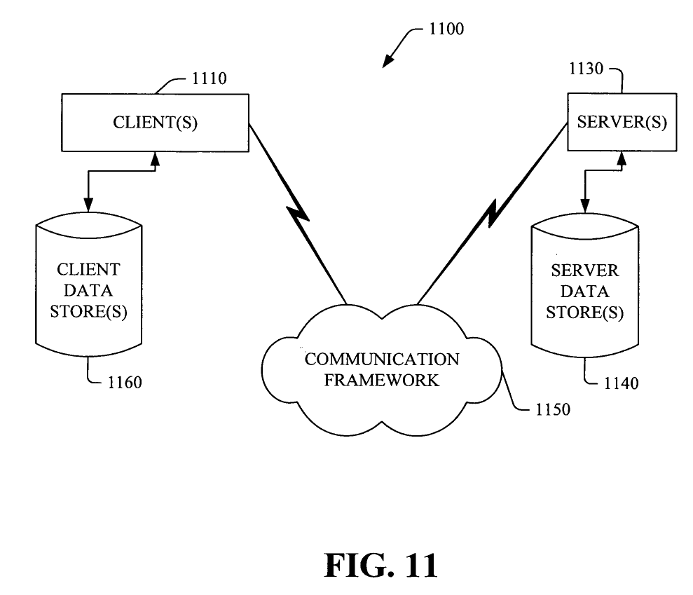

order to provide a context for the various aspects of the invention, FIGS. 10 and 11 as well as the following discussion are intended to provide a brief, general description of a suitable computing environment in which the various aspects of the user interfaces, methods and systems described herein may be implemented. Although the description above relates to the general context of computer-executable instructions of a computer program that runs on a computer and/or computers, those skilled in the art will recognize that the user interface, methods and systems also may be implemented in combination with other program modules. Generally, program modules include routines, programs, components, data structures, etc. that perform particular tasks and/or implement particular abstract data types.

Moreover, those skilled in the art will appreciate that the user interfaces, methods and systems described herein may be practiced with other computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules may be located in both local and remote memory storage devices. The user interface, methods and systems described herein may be embodied on a computer-readable medium having computer-executable instructions for implementing various aspects of the subject invention as well as signals manufactured to transmit such information, for instance, on a network.

FIG. 10 schematically illustrates an exemplary environment 1010 for implementing various aspects of the subject invention. The environment 1010 includes a computer 1012, which includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 10-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and Rambus Direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage device 1024. Disk storage device 1024 includes, but is not limited to, devices like a magnetic disk drive, floppy disk drive, tape drive, Jaz drive, Zip drive, LS-100 drive, flash memory card, or memory stick. In addition, disk storage device 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

In addition to hardware components, FIG. 10 illustrates software that acts as an intermediary between users and the basic computer resources described in suitable operating environment 1010. Such software includes an operating system 1028. Operating system 1028, which can be stored on disk storage devices 1024, acts to control and allocate resources of the computer system 1012. System applications 1030 take advantage of the management of resources by operating system 1028 through program modules 1032 and program data 1034 stored either in system memory 1016 or on disk storage devices 1024. The subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the user interfaces, methods and systems described herein. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 can connect to one or more client data store(s) 1160 that can be employed to store information local to the client(s) 1110. Similarly, the server(s) 1130 can connect to one or more server data store(s) 1140 that can be employed to store information local to the servers 1130.

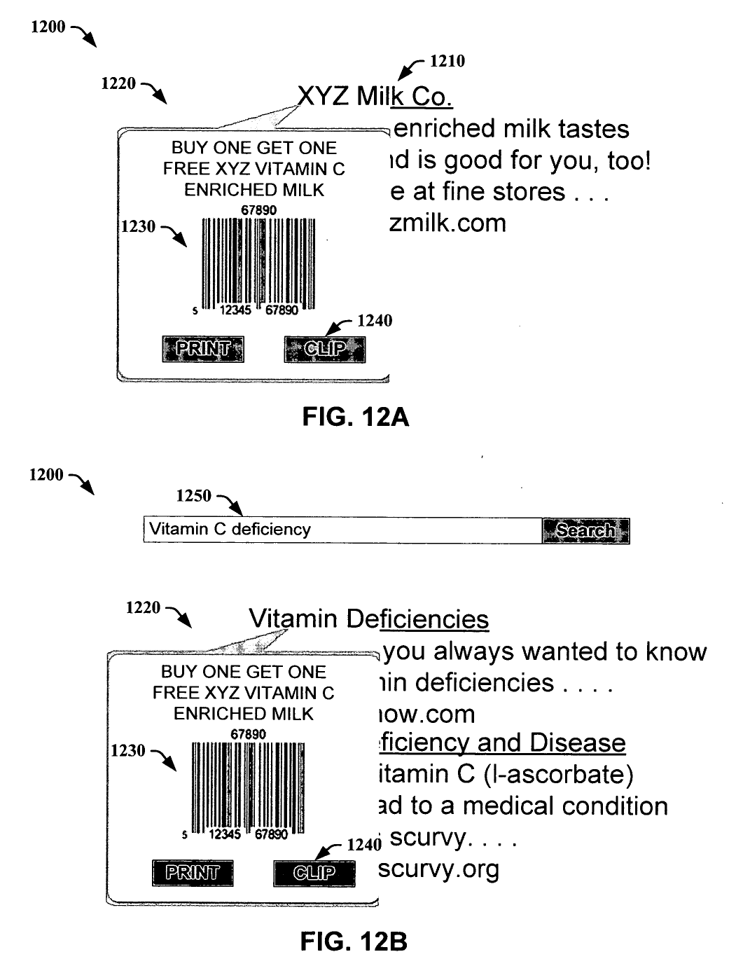

FIGS. 12A and 12B illustrate other examples of user interfaces 1200 that facilitate user interaction with an advertisement. As shown in FIG. 12A, a user may interact with a first advertisement 1210 to receive a second advertisement 1220. The second advertisement 1220 may include a coupon code 1230 that the user may print to take to a vendor to receive a discount when purchasing the advertiser's goods and/or services. Thus, the user interfaces 1200 may facilitate offline commerce. A user may also store the coupon 1230 to print later, for instance, by hitting a “clip” button 1240, which facilitates storing the coupon to print later. This functionality allows a user to clip several coupons and print them out together rather than printing them one at a time. As shown in FIG. 12B, a coupon code 1230 also may be presented to a user via a preview pane 1220 when a user enters a query 1250 that relates to the coupon 1230.

The coupons 1230 described above may be conveyed on a network, in whole or in part, by data signals. These manufactured data signals may be of any type and may convey the coupons 1230 on any type of network. For instance, the coupons 1230 may be conveyed by electronic signals propagating on electronic networks, such as the Internet. Wireless communications techniques and infrastructures also may be utilized to convey the coupons 1230.

What has been described above are examples of the subject invention. It is, of course, not possible to describe every conceivable combination of components or methodologies, but one of ordinary skill in the art will recognize that many further combinations and permutations of the subject invention are possible. Accordingly, the subject invention is intended to embrace all such alterations, modifications and variations that fall within the spirit and scope of the claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A user interface that facilitates a user's interaction with a vendor, comprising:
an electronic advertisement conveyed to a user in an ad space provided by a third party; and
a secondary advertisement occurring upon receiving a user indication, the secondary advertisement providing associated information relating to the electronic advertisement and thereby facilitating the user's interaction with the vendor.

2. The user interface of claim 1, the associated information comprising at least one of one or more links to one or more of the vendor's landing pages, audio content, video content, multimedia content, a coupon, a map of the vendor's place of business and an order form.

3. The user interface of claim 2, the order form being automatically at least partially filled-in.

4. The user interface of claim 1, the associated information comprising a preview of one or more pages of the vendor's online presence.

5. The user interface of claim 1, wherein the user interface provides one or more tertiary advertisements to the user upon receiving another user indication.

6. The user interface of claim 1, the third party being at least one of an email service, an application program, a web portal, and a search engine site.

7. The user interface of claim 1, the user indication being at least one of a hover, a voice signal, an input device click and an eye gaze.

8. The user interface of claim 1, wherein the secondary advertisement comprises a navigation component that facilitates navigation of the advertiser's web site.

9. The user interface of claim 1, wherein at least part of the user interface is conveyed by a manufactured data signal.

10. A method of providing supplementary online advertising information to a user, comprising:
providing one or more ads from a plurality of different advertisers in a first ad space, the first ad space maintained by an ad space supplier;
receiving a user input identifying at least one of the ads from the plurality of different advertisers; and
providing a second ad space having a supplemental ad, the supplemental ad relating to the at least one ad identified by the user input.

11. The method of claim 10, the supplemental ad comprising one or more links to one or more web pages, the web pages corresponding to an advertiser who placed the at least one ad identified by the user input in the first ad space.

12. The method of claim 10, the supplemental ad comprising at least one of audio content, video content, multimedia content, a coupon, a map and a preview of one or more web pages.

13. The method of claim 10, further comprising:
receiving a second user input relating to a portion of the supplemental ad; and
providing a third ad space having additional advertising information in response to the second user input.

14. The method of claim 10, the user indication being at least one of a hover over indication, a click indication, an audio indication and a visual indication.

15. The method of claim 10, further comprising:
providing a menu within the second ad space, the menu relating to a web site affiliated with an advertiser who placed the at least one ad identified by the user input in the first ad space.

16. The method of claim 10, wherein the ad space supplier is at least one of an email server, an application program, a web portal, and a search engine web page.

17. The method of claim 10, wherein the method is encoded by computer-executable instructions stored on computer-readable media.

18. The method of claim 10, wherein the method is encoded by computer-executable instructions conveyed by a manufactured data signal.

19. A system for enhancing a third party online advertising venue, comprising:
means for providing online advertisements from two or more separate advertisers to a user interacting with the third party online advertising venue;
means for providing a second advertisement, the second advertisement associated with at least one online advertisement; and
means for receiving a user indication from the user, the user indication indicating the at least one online advertisement associated with the second advertisement, wherein upon receiving the user indication, the means for receiving the user indication signals the means for providing the second advertisement to provide the second advertisement and wherein the means for providing the second advertisement provides the second advertisement to the user in response to the signal from the means for receiving the user indication.

20. The system of claim 19, wherein the system is conveyed by a manufactured data signal.
